(19) United States
(12) Patent Application Publication
(10) Pub. No.: US 2009/0191383 A1
(43) Pub. Date: Jul. 30, 2009

(54) METHOD FOR COLORING TEXTILE SUBSTRATES, AQUEOUS PRETREATMENT BATHS, AND USE THEREOF FOR THE PRETREATMENT OF TEXTILE SUBSTRATES

(75) Inventors: Michael Kluge, Worms (DE); Cedric Dieleman, Scheibenhard (FR); Mike Freche, Kerzenheim (DE); Clarissa Seidl, Sinsheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 11/571,025

(22) PCT Filed: Jun. 22, 2005
(86) PCT No.: PCT/EP2005/006719

§ 371 Date: Dec. 20, 2006

(30) Foreign Application Priority Data
Jun. 29, 2004 (DE) 10 2004 031 530.2

(51) Int. Cl. B32B 3/10; D06P 5/30; D06M 15/564; D06M 15/61

(52) U.S. Cl. 428/195.1; 8/445; 252/8.81

(57) ABSTRACT

A process for coloring a textile substrate comprises a textile substrate
(a) being pretreated with an aqueous pretreatment liquor comprising
   (A) at least one resin selected from melamin derivatives, dimethyloldihydroxy-ethyleneurea (DMDHEU) and derivatives of DMDHEU, and
   (B) at least one thickener, and thereafter
(b) being printed by the ink jet process.

The present invention relates to a process for coloring a textile substrate, which comprises a textile substrate

(a) being pretreated with an aqueous pretreatment liquor comprising
(A) at least one resin selected from melamine derivatives, dimethyloidihydroxy-ethyleneurea (DMDHEU) and derivatives of DMDHEU, and
(B) at least one thickener, and thereafter
   (b) being printed by the ink jet process.

The present invention further relates to aqueous pretreatment liquors and pretreatment compositions. The present invention finally relates to textile substrates obtainable by the process of the present invention.

It is known to treat textile materials which are to be printed by the ink jet process for example with a pretreatment liquor to improve the application properties of the printed textiles. This pretreatment is intended to improve ink holdout on the textile substrate and to achieve a higher color strength and also better fixation of the inks on the substrate. Goals include distinctly crisper contours (improved definition) for the prints on the substrate in order that higher resolutions (higher dpi) may be achieved for the prints. Goals further include high in-service fastnesses, for example washfastness and rubfastness.

EP-A 0 928 841 describes the use of natural thickeners and of bivalent metal salts to print direct dyes and pigments onto silk.

WO 99/33669 discloses pretreating a textile with cationic compounds prior to printing to improve holdout of disperse dye inks, the cationic compounds mentioned being of low molecular weight.

U.S. Pat. No. 6,001,137 describes the use of polycationic compounds based on epichlorohydrin copolymers to improve fixation. No improvement to ink holdout is described.

WO 00/03081 describes a pretreatment of textiles for ink jet printing with pigments. WO 00/03081 proposes in this connection that textiles be treated with a pretreatment liquor comprising textile binders and melamine crosslinkers. Printing is then done with an ink comprising a thickener.

JP 62231787 describes the use of bivalent inorganic metal salts and/or cationic compounds and crosslinkers to prepare a textile for ink jet printing with pigments. The crosslinker leads to crosslinking with a binder comprised in the ink.

WO 00/56972 describes the use of cationic polymers and copolymers and also of polymer latices as binders for pretreating textile substrates for ink jet printing.

The definition of the printed image on the textile substrate is frequently insufficient in existing processes. This is due to inks spreading on the substrate.

WO 2004/031473 discloses pretreating textiles with a pretreatment liquor comprising at least one polycationic compound and at least one thickener. The textiles obtained exhibit improved ink holdout when printed. Fabric hand of printed textiles thus obtainable, although not adversely affected, could do with improvement in many cases. The rubfastnesses of printing with inks based on pigments are, however, in need of improvement.

The present invention therefore had for its object to provide a process which avoids the disadvantages mentioned at the beginning and especially provides textiles which, after printing, have an at least unchanged, but ideally improved fabric hand. Furthermore, inks shall exhibit improved holdout on printing. The present invention further had for its object to provide pretreatment liquors for producing textiles which are printable with crisp contours and which exhibit improved fabric hand and improved rubfastnesses after printing. The present invention further had for its object to provide printed textiles which avoid the above-identified disadvantages of the prior art, especially any deterioration in fabric hand.

We have found that this object is achieved by the process defined at the beginning.

The process of the present invention utilizes textile substrates which may take any form and may consist of any desired materials, for example fibers, yarns, threads, knits, wovens, nonwovens and garments composed of polyester, modified polyester, polyester blend fabric, cellulosic materials such as cotton, cotton blend fabric, jute, flax, hemp and ramie, viscose, wool, silk, polyamide, polyamide blend fabric, polyacrylonitrile, triacetate, acetate, polycarbonate, polypropylene, polyvinyl chloride, polyester microfibers and glass fiber fabric.

Preference is given to utilizing sheetlike textile substrates such as for example wovens and knits.

According to the present invention, textile substrates are initially treated in step (a) with an aqueous pretreatment liquor comprising
(A) at least one resin selected from melamine derivatives, dimethyloldihydroxy-ethyleneurea (DMDHEU) and derivatives of DMDHEU, and
(B) at least one thickener.

Examples of useful resins (A) are dimethyloldihydroxyethyleneurea (DMDHEU)

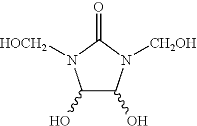

and derivatives of DMDHEU, for example etherification products of DMDHEU with for example C₁-C₄-alkanol, especially with methanol and with ethanol. Further useful derivatives of DMDHEU are bridged derivatives disclosed in EP 0 923 560, and mixedly alkylated or hydroxyalkoxyalkylated bis-4,5-dihydroxyimidazolidin-2-ones as described in WO 98/29393.

Preference is given to choosing resins (A) from melamine derivatives which may be singly to sixtuply condensed with one or more aldehydes and etherified with at least one aliphatic alcohol. At least one aldehyde is selected from C₆-C₁₄-arylaldehydes, for example 2-naphthaldehyde, 1-naphthaldehyde and especially benzaldehyde,

and aliphatic aldehydes such as
C₁-C₁₀-alkylaldehydes, wherein C₁-C₁₀-alkyl is selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl; more preferably C₁-C₄-alkyl such as methyl, ethyl, n-propyl, Isopropyl, n-butyl, isobutyl, sec-butyl and tert-butyl;
   and most preferably formaldehyde.

Useful aliphatic alcohols include C₁-C₁₀-alkanols, especially primary C₁-C₋₁₀-alkanols and most preferably methanol and ethanol. Useful aliphatic alcohols further include polyhydric alcohols such as for example ethylene glycol, propylene glycol, butylene glycol, pentane-1,2-diol, hexane-1,2-diol, 1,3-propanediol, 1,4-butanediol, 1,6-hexanediol, 1,12-dodecanediol, diethylene glycol, triethylene glycol, tetraethylene glycol, dipropylene glycol, tripropylene glycol, tetrapropylene glycol, glycerol, diglycerol, triglycerol, polyethylene glycol having on average from 5 to 50 ethylene oxide units per molecule (number average), polypropylene glycol having on average from 4 to 50 propylene oxide units per molecule (number average), ethylene oxide-propylene oxide copolymers, which may have a random, alternating or blocklike construction, having on average from 2 to 50 alkylene oxide units (number average) per molecule, alkylene oxide units being selected from ethylene oxide and propylene oxide, and polytetrahydrofurans having a molecular weight Mₙ in the range from 150 to 2 500 g/mol and preferably in the range from 200 to 300 g/mol.

Resin (A) is preferably a melamine derivative, for example a melamine derivative of the general formula I

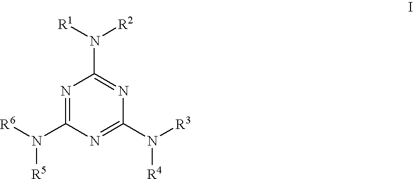

where R¹ to R⁶ are the same or different and are each defined as follows:
hydrogen or
(CHR⁸—O)_{z}R⁷, CHR⁸—OR⁷ or CH(OR⁷)₂ or CH₂—N(R⁷)₂
where z is in the range from 1 to 10 and may but need not be an integer,
and where R⁷ is in each occurrence the same or different and selected from
hydrogen,
C₁-C₁₂-alkyl, branched or unbranched, selected from C₁-C₁₂-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl; preferably C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, more preferably C₁-C₄-alkyl such as methyl, ethyl, n-propyl, isopropyl, n-butyl, isobutyl, sec-butyl and tert-butyl;
   alkoxyalkylene such as for example (—CH₂—CH₂O)ₘ—H, (—CHCH₃—CH₂—O)ₘ—H, (—CH₂—CHCH₃—O)ₘ—H, (—CH₂—CH₂—CH₂—CH₂—O)ₘ—H, where m is an integer from 1 to 20, preferably from 1 to 10 and more preferably from 1 to 5.
R⁸ is in each occurrence different or preferably the same and selected from C₆-C₁₄-aryl and especially phenyl,
   C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl; preferably C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, more preferably C₁-C₄-alkyl such as methyl, ethyl, n-propyl, isopropyl, n-butyl, isobutyl, sec-butyl and tert-butyl;
   and most preferably hydrogen.

The R¹, R³ and R⁵ radicals are preferably different.

It is more preferable for R¹ and R² to be hydrogen and more preferable for R³ and R⁴ each to be CH₂—OH. It is most preferable for R¹ and R² each to be hydrogen and for R³ to be CH₂—OH.

Many melamine derivatives of the general formula I are known per se and are commercially available, for example as Luwipal® from BASF Aktiengesellschaft and as Cymel® 327 from Cytec. Melamine derivatives for the purposes of the present invention are generally not pure in the sense of having one defined formula; typically, one observes intermolecular rearrangements of the R¹ to R⁶ radicals, i.e., transacetalization reactions and transaminalization reactions, and also to a certain degree condensation reactions and elimination reactions. The formula V indicated above is to be understood as defining the stoichiometric ratios of the substituents and as comprising intermolecular rearrangement products and condensation products as well.

The melamine derivatives which are most preferably used as resin (A) are obtainable by reaction of melamine with one to three, preferably with 1.4 to 2.8 and more preferably with 1.5 to 2.6 equivalents of at least one aliphatic aldehyde, for example propionaldehyde, acetaldehyde and especially formaldehyde. This reaction is followed by an etherification with 4.5 to 15 equivalents, preferably up to 10 and more preferably up to 6 equivalents of at least one di- or more highly hydric aliphatic alcohol.

Neither the reaction with aliphatic aldehyde or aliphatic aldehydes nor the etherification need be effected in a stoichiometrically unitary way, so that representation of the melamine derivatives according to the present invention by a formula is not possible. On the contrary, mixtures of various products which continue to be accessible to transaminalization reactions and transetherification reactions are typically obtained.

Melamine derivatives used as resin (A) in the present invention are preparable in a conventional manner. Melamine derivatives which are particularly preferred for use as resin (A) are preparable by initially reacting melamine with one to three equivalents of at least one aliphatic aldehyde and then etherifying the reaction product with 4.5 to 10 equivalents of at least one polyhydric aliphatic alcohol.

The reaction of melamine with at least one aliphatic aldehyde in one embodiment of the present invention is carried out in aqueous solution, preferably at pH values in the range from 7 to 10 and more preferably at pH values in the range from 8 to 9. In another version no water is used and melamine and at least one aldehyde, especially melamine and paraformaldehyde, are mixed and the two reactants are made to react with each other.

In one version the reaction of melamine with at least one aliphatic aldehyde is carried out at temperatures in the range from 50 to 105° C. and preferably in the range from 70 to 90° C.

In one version the reaction of melamine with at least one aliphatic aldehyde is carried out at atmospheric pressure, in another embodiment of the present invention the reaction of melamine with at least one aliphatic aldehyde is carried out at pressures in the range from 1.01 to 50 bar and preferably up to 10 bar.

In one version the reaction of melamine with at least one aliphatic aldehyde is carried out in the presence of at least one catalyst, examples being sodium hydroxide and potassium hydroxide.

In one version the etherification with at least one polyhydric aliphatic alcohol is carried out in aqueous phase at pH values in the range from 1 to 6 and preferably in the range from 5 to 5.5. Desired pH values can be set by addition of an acid such as for example trifluoroacetic acid, methylsulfonic acid, para-toluenesulfonic acid, benzenesulfonic acid, sulfuric acid, phosphoric acid or nitric acid.

In one version the etherification with at least one polyhydric aliphatic alcohol is carried out at temperatures in the range from 20 to 100° C. and preferably in the range from 30 to 70° C.

In one version the etherification with at least one polyhydric aliphatic alcohol is carried out at atmospheric pressure. In another embodiment of the present invention the etherification with at least one polyhydric aliphatic alcohol is carried out at pressures in the range from 1.01 to 50 bar.

After the etherification has ended, excess aliphatic aldehyde can be distilled off. It is also possible not to distill off excess aliphatic aldehyde and for excess aliphatic aldehyde to be removed from the reaction equilibrium by means of suitable reagents, for example oxidizing agents such as nitric acid for example.

In one preferred version the melamine derivatives preferred for use as resin (A) are prepared by omitting distillations between the reaction of melamine with at least one aldehyde and the etherification with at least one polyhydric aliphatic alcohol.

In one embodiment of the present invention melamine derivatives preferred for use as resin (A) are isolated, for example by evaporating any solvents used such as water in particular. Spray drying is a particularly suitable method of isolating melamine derivatives used as resin (A) in the present invention.

In another embodiment of the present invention melamine derivatives preferred for use as resin (A) are not isolated but used in the form of dispersions, preferably in the form of aqueous dispersions.

According to the present invention, aqueous pretreatment liquors further comprise at least one thickener (B).

Useful thickeners (B) include natural thickeners such as alginates, polysaccharides, starch, carboxymethylcellulose, guar gum powder and also derivatives thereof, and synthetic thickeners such as if appropriate acrylic acid homo- and copolymers, which may be crosslinked, for example by interpolymerization of at least one compound of the general formula

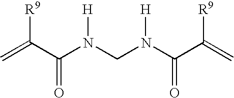

in each of which R⁹ is methyl or preferably hydrogen.

Preferred thickeners (B) are associative thickeners of the general formula I, II and/or III

U-[-T-(E)_{y}-]ₓ—U I

U-(E)_{y}-U II

U-T-U III

where
E is in each occurrence the same or different and selected from —CH₂—CH₂—, —CH₂—CH(CH₃)—, —CH₂—CH(C₂H₅)—,
y is an integer from 1 to 100 000 and preferably in the range from 10 to 10 000,
T is in each occurrence the same or different and a diisocyanate-derived unit,
x is an integer from 1 to 500, preferably in the range from 1 to 2 and more preferably about 1,
U is in each occurrence the same or different and selected from units derived from aliphatic or aromatic alcohols, thiols, amines or carboxylic acids each having 4 or more carbon atoms and preferably not less than 6 carbon atoms, aromatic alcohols, thiols, amines or carboxylic acids each having 6 or more carbon atoms, alcohols, thiols, amines or carboxylic acids having C₇-C₁₃-aralkyl moieties or heteroaromatic alcohols, thiols, amines or carboxylic acids.

Associative thickeners of the general formula I are obtainable by reaction of
(i) at least one polyetherdiol with
(ii) at least one diisocyanate and
(iii) at least one compound of the general formula R¹⁰—OH, R¹⁰—SH. R¹⁰—NH₂, R¹⁰R¹¹NH or R¹⁰—COOH, where R¹⁰ and R¹¹ may be the same or different and are each selected from aliphatic radicals having not less than 4 carbon atoms, aromatic radicals having not less than 6 carbons and heteroaromatic radicals and where R¹⁰—OH may be alkoxylated, and also further derivatives of these compounds that are capable of forming a urethane, thiourethane or urea bond.

Preferred polyetherdiols (i) for the purposes of the present invention are polyethylene glycol, polypropylene glycol and polytetrahydrofuran, but also copolymers of ethylene oxide and propylene oxide or butylene oxide or terpolymers of ethylene oxide, propylene oxide and butylene oxide, which copolymers may take the form of block copolymers or random copolymers or terpolymers.

Useful diisocyanates (ii) include diisocyanates having NCO groups of the same or a different reactivity. Examples of diisocyanates having NCO groups of the same reactivity are aromatic or aliphatic diisocyanates, preference being given to aliphatic diisocyanates such as tetramethylene diisocyanate, hexamethylene diisocyanate (HD1), octamethylene diisocyanate, decamethylene diisocyanate, dodecamethylene diisocyanate, tetradecamethylene diisocyanate, trimethylhexane diisocyanate, tetramethylhexane diisocyanate, 1,4-, 1,3- or 1,2-diisocyanatocyclohexane, 4,4′-dilsocyanatocyclohexylmethane, 1-isocyanato-3,3,5-trimethyl-5-isocyanato-methylcyclohexane (isophorone diisocyanate) and 2,4- and 2,6-diisocyanato-1-methylcyclohexane, of which hexamethylene diisocyanate and isophorone diisocyanate are particularly preferred. A further particularly preferred diisocyanate is m-tetramethylxylene diisocyanate (TMXDI).

Preferred diisocyanates having NCO groups of differing reactivity are the readily and inexpensively available isocyanates such as for example 2,4-tolylene diisocyanate (2,4-TDI), 2,4′-diphenylmethane diisocyanate (2,4′-MDI), triisocyanatotoluene as representatives of aromatic diisocyanates or aliphatic diisocyanates, such as 2-butyl-2-ethylpentamethylene diisocyanate, 2-isocyanatopropylcyclohexyl isocyanate, 2,4,4- or 2,2,4-trimethylhexamethylene diisocyanate, 2,4′-methylenebis(cyclohexyl) diisocyanate and 4-methylcyclohexane 1,3-diisocyanate (H-TDI).

Further examples of isocyanates having groups differing in reactivity are 1,3-phenylene diisocyanate, 1,4-phenylene diisocyanate, 1,5-naphthylene diisocyanate, diphenyl diisocyanate, toluidine diisocyanate and 2,6-tolylene diisocyanate.

It is naturally also possible to use mixtures of two or more of the aforementioned isocyanates for synthesis.

Polyisocyanates can be used to a certain extent alongside diisocyanates, for example in amounts of up to 10% by weight based on the total amount of di- and polyisocyanate. Examples of useful polyisocyanates are biurets and aliophanates of HDI or TDI.

Very particularly preferred diisocyanates (ii) are HDI, IPDI, MDI and TDI.

The molar ratio of polyetherdiols (i) to diisocyanates (ii) is generally in the range from 0.3:1 to 1:1 and preferably about 0.5:1.

The reaction of diisocyanate (ii) with polyetherdiol (i) is typically carried out in the presence of one or more catalysts.

The catalyst or catalysts are preferably used in an amount from 0.01% to 10% by weight and preferably from 0.05% to 5% by weight, based on diisocyanate (ii). Useful catalysts to speed especially the reaction between the NCO groups of diisocyanate (ii) and the hydroxyl groups of polyetherdioi (i) are well-known tertiary amines, for example triethylamine, dimethylcyclohexylamine, N-methylmorphoilne, N,N′-dimethylpiperazine, 2-dimethylaminoethoxyethanol, 1,4-diazablcyclo[2.2.2]-octane (DABCO) and the like and also in particular organic metal compounds such as titanate esters, iron(III) acetylacetonate, tin compounds, for example tin diacetate, tin dioctanoate, tin dilaurate or the dialkyl derivatives of tin dialkyl salts of aliphatic carboxylic acids such as dibutyltin diacetate, dibutyltin dilaurate or the like.

The synthesis of the associative thickeners (B) is generally carried out without a solvent or in an aprotic solvent, with a suitable solution being in principle any solution which reacts neither with polyurethane nor with polyetherdiol (i) nor with diisocyanate (ii), for example tetrahydrofuran, diethyl ether, diisopropyl ether, chloroform, dichloromethane, di-n-butyl ether, acetone, N-methylpyrrolidone (NMP), xylene, toluene, methyl ethyl ketone (MEK), methyl isobutyl ketone (MIBK) or 1,4-dioxane. Preferred reaction temperatures are in the range from −20° C. to the boiling point of the solvent used. The reaction is generally carried out under atmospheric pressure, but it may also be carried out in autoclaves at up to 20 bar.

Reacting NCO-terminated products of polyetherdiol (i) with diisocyanate (ii) with aliphatic or aromatic alcohols, thiols, primary or secondary amines or carboxylic acids (iii) converts the reaction products of the components (i) and (ii), which comprise free isocyanate groups, into hydrophobicized products.

Suitable are in particular alcohols R¹⁰—OH and primary or secondary amines R¹⁰—NH₂ and R¹⁰R¹¹NH, in each of which R¹⁰ and R¹¹ may be the same or different and are each selected from

C₄-C₆₀-alkyl such as for example n-butyl, isobutyl, n-pentyl, preferably C₆-C₄₀-alkyl such as for example n-hexyl and n-heptyl and especially C₈-C₄₀-alkyl such as for example n-octyl, n-nonyl, n-decyl, n-dodecyl, n-hexadecyl or n-eicosyl;
C₆-C₁₄-aryl such as phenyl, α-naphthyl, β-naphthyl, 1-anthracenyl, 2-anthracenyl or 9-anthracenyl
heteroaromatic radicals such as α-pyridyl, β-pyridyl, γ-pyridyl, N-pyridyl, 8-pyridyl, γ-pyridyl, porphyrinyl, 2-furanyl, 3-furanyl, 2-thiophenyl, 3-thiophenyl, N-pyrazolyl, N-imidazolyl, N-triazolyl, N-oxazolyl, N-indolyl, N-carbazolyl, 2-benzofuranyl, 2-benzothiophenyl, N-indazoyl, benzotriazolyl, 2-quinolinyl, 3-isoquinolinyl and α-phenanthrolinyl;
C₇-C₁₃-aralkyl, preferably C₇ to C₁₂-phenylalkyl such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl and 4-phenylbutyl, more preferably benzyl.

Alcohols R¹⁰—OH may also have been alkoxylated with one or more equivalents of ethylene oxide, propylene oxide or butylene oxide, in which case not only homo- but also (block) copolymers of the identified alkylene oxides can be used, typically having about 20-500 alkylene oxide units. The alcohols R—OH may further be alkoxylated with THF.

In general, the compound of the general formula R¹⁰—OH, R¹⁰—SH, R¹⁰—NH₂, R¹⁰R¹¹NH or R¹⁰—COOH (iii) is used with regard to the free isocyanate groups in an at least stoichiometric amount, but frequently in stoichiometric excess, for example from 50 to 100 mol %, based on free NCO groups.

Hydrophobic groups R¹⁰ may also be attached to polyetherdiol (i) via an ester or ether bridge. Associative thickeners of the general formula II are thus obtainable for example by reaction of

polyetherdiols (i) with
one or more compounds of the general formula R¹⁰—OH or R¹⁰—COOH, where R¹⁰ has the above-identified meanings, or further derivatives of these compounds that are capable of forming an ether or ester bond.

Associative thickeners of the formula III are obtained for example from diisocyanate (ii) and at least one compound of the general formula R¹⁰—OH, R¹⁰—SH, R¹⁰—NH₂. R¹⁰R¹¹NH or R¹⁰—COOH (iii) without polyetherdiols (i) being present. In this reaction, the compound of the general formula R¹⁰—OH, R¹⁰—SH, R¹⁰—NH₂, R¹⁰R¹¹NH or R¹⁰—COOH (iii) or to be more precise the compounds (iii) may be used in stoichiometric excess, based on diisocyanate (ii).

To practice the process of the present invention, textile substrates are treated with at least one aqueous pretreatment liquor comprising the above-described components (A) and (B). To treat a textile substrate with an aqueous pretreatment liquor comprising the above-described components (A) and (B), hereinafter also referred to as inventive aqueous pretreatment liquor, the textile substrate is contacted at least once with inventive aqueous pretreatment liquor and subjected to the action thereof for a certain period, for example for a period in the range from 0.1 second to 2 hours, and is subsequently removed as pretreated textile substrate. Contacting can be effected in various ways. It is possible for example to apply inventive aqueous pretreatment liquor to textile substrate, for example by exhaust processes or batch or continuous processes involving forced application.

Exhaust processes will be suitable whenever the inventive aqueous pretreatment liquor possesses distinct affinity for textile substrate, for example due to different ionogenicities. There are various forms of the exhaust process which are known in principle from the field of textile dyeing. For example, the textile substrate can be in a wound-up state and inventive aqueous pretreatment liquor forced under pressure through the wound-up textile substrate, in which case the inventive aqueous pretreatment liquor can flow from in to out or else, in fully flooded machines, from out to in. To ensure uniform application, at least one change in the direction of flow of inventive aqueous pretreatment liquor during the pretreatment is advantageous. In another embodiment, textile substrate is present in an unconstrained state in the inventive aqueous pretreatment liquor and moves therewith. In a further embodiment, textile substrate can be pulled through a standing bath comprising inventive aqueous pretreatment liquor. Advantageously, textile substrate is repeatedly pulled through inventive aqueous pretreatment liquor and the direction of movement of the textile substrate should reverse. This is conducive to uniform application. More particular details concerning these application processes can be found in the relevant literature, for example Veredlung von Textilien, VEB Fachbuchverlag Leipzig, 1st edition 1976, pages 93 ff.

Useful continuous processes for application include all processes whereby the pretreatment composition of the present invention can be applied uniformly or imagewise. Of particular suitability here are all printing processes and also all processes in which the textile is uniformly drenched with the inventive aqueous pretreatment liquor. The difference to exhaust processes is that a forced application is realized. The inventive aqueous pretreatment liquor need not have any affinity for fiber for these processes.

Useful printing processes include for example all screen printing processes. Screen printing processes are important processes which are known in principle and are utilized inter alia in the production of printed fabrics. In screen printing, inventive aqueous pretreatment liquor is forced by a squeegee through a fine mesh and onto textile substrate to be pretreated. The mesh can be formed from synthetic fibers, as in flat screen printing machines, or metals, as in rotary screen printing machines.

But relief printing, gravure printing or roller printing, being common textile printing processes, are also useful for applying inventive aqueous pretreatment liquor. Details concerning individual printing processes can be found on pages 110 ff. of the literature reference cited above.

As well printing processes, however, it is also possible to use any technique wherein textile substrate is uniformly drenched with inventive aqueous pretreatment liquor. This can be accomplished for example using pad-mangle technology wherein textile substrate is led through a trough filled with inventive aqueous pretreatment liquor and subsequently squeezed off by two rolls to a defined wet pickup. It is also possible to lead textile substrate through a nip formed between two rotating rollers and filled with inventive aqueous pretreatment liquor. The rollers lead to an intensive contacting of textile substrate with inventive aqueous pretreatment liquor while at the same time squeezing off the textile substrate to the desired wet pickup. There are in addition many other possible configurations for this pad-mangle technology, which are all likewise useful for applying inventive aqueous pretreatment liquor.

Defined amounts of inventive aqueous pretreatment liquor can be applied by well-known spraying and pouring techniques.

Foam application methods are also suitable.

In one embodiment of the present invention textile substrate is contacted with sufficient pretreatment liquor to apply from 0.1 to 30 g of solids/m² of textile substrate, preferably from 1 g/m² to 25 g/m² and more preferably up to 15 g/m².

In one embodiment of the present invention the temperature chosen for the pretreatment liquor is in the range from 20° C. to 80° C.

To proceed by pad-mangle technology, the rolls may be set to a nip pressure in the range from 2 to 3 bar for example.

In one embodiment of the present invention the contacting of textile substrate with inventive aqueous pretreatment liquor may be followed by drying, for example to a residual moisture content in the range from 5% to 30% by weight.

This may be accomplished by heating textile substrate which has been contacted with inventive aqueous pretreatment liquor such that water present is fully or partially able to evaporate off. It is preferable to employ temperatures in the range from 80 to 100° C., The heat needed can be introduced in the form of heated air as a heat transfer agent. But it is also possible to use infrared radiators or microwave radiators. Preferably, the textile substrate is kept under tension in the drying operation in order that the formation of creases may be avoided.

In one embodiment of the present invention one or more salts of uni- or bivalent metals or ammonium salts may be added to inventive pretreatment liquors. Examples of useful salts are ZnCl₂, Zn(NO₃)₂, each in its hydrated or nonhydrated form, NH₄Cl, (NH₄)₂SO₄, NaBF₄, AlCl₃.6H₂O, ammonium dihydrogen phosphate, diammonium hydrogen phosphate, and most preferably MgCl₂, for example in the form of its hexahydrate.

When inventive pretreatment liquors comprise one or more salts of uni- or bivalent metals or ammonium salts, the amounts will typically be in the range from 0.1% to 30% by weight, based on resin (A), preferably in the range from 0.5% to 10% and more preferably in the range up to 8% by weight.

Step (b) of the process according to the present invention comprises printing pretreated and if appropriate dried textile substrate, preferably by the ink jet process.

The ink jet process utilizes inks, which may be solvent or preferably water borne, that are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted ink jet or drop-on-demand process, in which the ink is expelled only where a colored dot is to appear, the latter form of the process employing either a piezoelectric crystal or a heated hollow needle (bubble jet process) to exert pressure on the ink system and so eject the ink droplets. These techniques are described in Text. Chem. Color, volume 19 (8), pages 23 to 29, 1987, and volume 21 (6), pages 27 to 32, 1989.

The ink jet inks used for printing textile substrates in the process of the present invention, as well as one or more dispersants, typically comprise water or water-solvent mixture and also finely divided organic or inorganic colorants which are preferably substantially insoluble in water or in the water-solvent mixture, examples being pigments as defined in German standard specification DIN 55944. Disperse dyes can be used instead of pigments. But ink jet inks can also comprise direct, acid, reactive and vat dyes as dissolved dyes. The soluble dyes mentioned can be present as brightening agents in pigment-based ink jet inks, in which case soluble dyes (especially direct, acid or reactive dyes) which are similar in hue to the pigment are used.

Step (b) is particularly preferably carried out using at least pigment-based ink jet ink which, as well as at least one pigment and water, comprises at least one dispersant.

Useful dispersants include for example those based on maleic acid-acrylic acid copolymers, especially those having an Mₙ molecular weight in the range from 2 000 to 10 000 g/mol, which are useful in the form of random copolymers or block copolymers. Useful dispersants further include N-vinylpyrrolidone homopolymers and acrylate-N-vinylpyrrolidine copolymers, especially N-vinylpyrrolidone homopolymers and acrylate-N-vinylpyrrolidine copolymers having an Mₙ molecular weight in the range from 2 000 to 10 000 g/mol, in the form of random copolymers or block copolymers.

Useful dispersants also include those based on naphthalenesulfonic acid-formaldehyde condensates, for example according to U.S. Pat. No. 5,186,846, or based on alkoxylated styrylated and if appropriate sulfated alkylphenols or bisphenols for example according to U.S. Pat. No. 4,218,218.

Useful dispersants further include random polyurethane copolymers as disclosed for example in WO 2004/31255 page 3 ff.

Ink jet inks used in step (b) preferably comprise at least one solvent having a boiling point above 110° C., examples being ethylene glycol, diethylene glycol, triethylene glycol, tetraethylene glycol, glycerol, diglycerol, propylene glycol, dipropylene glycol, room temperature liquid polytetrahydrofuran, 1,3-propanediol, mono-, di- or triethylene glycol mono-C₁-C₄-alkyl esters in each of which C₁-C₄-alkyl is selected from methyl, ethyl, n-propyl, isopropyl, n-butyl, isobutyl, sec-butyl and tert-butyl.

In one embodiment of the present invention, ink jet inks used in step (b) have a dynamic viscosity in the range from 1 to 30 mPa·s, preferably in the range from 1 to 20 mPa·s and more preferably in the range from 2 to 15 mPa·s, all determined at 20° C.

In one embodiment of the present invention, ink jet inks used in step (b) have a surface tension in the range from 20 to 70 mN/m, especially in the range from 20 to 40 mN/m and more preferably in the range from 25 to 35 mN/m, all determined at 20° C.

The pH of ink jet inks used in step (b) is generally in the range from 5 to 10 and preferably in the range from 7 to 9.

Ink jet inks used in step (b) may comprise further auxiliaries of the kind customary especially for aqueous ink jet inks and in the printing and coatings industry. Examples of such auxiliaries include erythritol, pentaerythritol, pentitols such as arabitol, adonitol and xylitol and hexifols such as sorbitol, mannitol and dulcitol. Further examples are polyethylene glycols having an M_{w} in the range from more than 2 000 g/mol to about 10 000 g/mol and preferably up to 800 g/mol. Further examples are preservatives such as for example 1,2-benzisothiazolin-3-one and its alkali metal salts, degassers/defoamers such as for example ethoxylated acetylenediols, which typically comprise from 20 to 40 mol of ethylene oxide per mole of acetylenediol and may also have a dispersing effect, viscosity regulators, flow agents, wetters (examples being wetting surfactants based on ethoxylated or propoxylated fatty or oxo alcohols, propylene oxide-ethylene oxide block copolymers, ethoxylates of oleic acid or alkylphenols, alkylphenol ether sulfates, alkylpolyglycosides, alkylphosphonates, alkylphenylphosphonates, alkyl phosphates, alkylphenyl phosphates, or preferably polyethersiloxane copolymers, especially alkoxylated 2-(3-hydroxypropyl)heptamethyl-trisiloxanes, which generally have a block of 7 to 20 and preferably 7 to 12 ethylene oxide units and a block of 2 to 20 and preferably 2 to 10 propylene oxide units and may be present in the colorant preparations in amounts from 0.05% to 1% by weight), anti-settlers, luster improvers, lubricants, adhesion promoters, anti-skinning agents, delusterants, emulsifiers, stabilizers, hydrophobicizers, light control additives, antistats, bases such as for example K₂CO₃ or acids, specifically carboxylic acids such as for example lactic acid or citric acid to regulate the pH. When these agents are part of ink jet inks used in step (b), their total amount will generally be 2% by weight and especially 1% by weight, based on the weight of the colorant preparations of the present invention and especially of the ink jet process inks of the present invention.

In one embodiment of the present invention, no hand improvers need be added to the ink jet inks used in step (b).

Inks used in step (b) may comprise one or more resins (A) in fractions of up to 10% by weight.

In one embodiment of the present invention, textile substrate is

(a) pretreated with at least one aqueous pretreatment liquor comprising
(A) at least one resin selected from melamine derivatives, dimethyloldihydroxy-ethyleneurea (DMDHEU) and derivatives of DMDHEU,
(B) at least one thickener,
(C) optionally at least one polycationic compound, and
(D) optionally at least one additive
   (b) and thereafter printed by the ink jet process.

Resins (A) and thickeners (B) are each as defined above.

Aqueous pretreatment liquors according to the present invention may comprise one or more polycationic compounds as component (C).

Useful polycationic compounds include for example cationic homopolymers or copolymers. Preferred polycationic compounds are polyvinylamines, for example having Fikentscher K values in the range from 15 to 60, polyethylenimines, for example having an Mₙ molecular weight in the range from 5 000 to 1 000 000 g/mol, homo- or copolymers of diallyldialkylammonium monomers, such as diallyldimethylammonium chloride, cationic acrylates and acrylamides such as acryloyloxyethyldimethyl-ammonium chloride or acrylamidoethyldimethylammonium chloride, quaternary vinylpyridines such as methylvinylpyridine chloride, polyalkylamlne polymers and copolymers, also polyallylamine hydrochloride, allylamine hydrochloride-diallylamine hydrochloride copolymer, N-vinylacryloylamidine hydrochloride-acrylamide copolymer, dialkylamine-epichlorohydrin polymer, polyamide-polyamine-epichlorohydrin polymer, dicyandiamide-formaldehyde polycondensate, polyethylenepolyamine-dicyandiamide polycondensate, polyethyleneimine hydrochloride, poly(meth)acryloyloxyalkyldialkyl-amine hydrochloride, (meth)acryloyloxyalkyldialkylamine hydrochloride-acrylamide copolymer and poly(meth)acryloyloxyalkyl trialkylammonium chloride.

Preferred polycationic compounds (C) are homo- or copolymers of diallyldialkyl-ammonium monomers, such as polydiallyldimethylammonium chloride (polyDADMAC), polydiallyldiethylammonium chloride (polyDADEAC), polydiallyldimethylammonium bromides (polyDADMABs), polydiallyldiethylammonium bromide (polyDADEAB), particular preference is given to polymers or copolymers of diallyldimethylammonium chloride and especial preference is given to diallyldimethylammonium chloride homopolymer (polyDADMAC).

Copolymers of the monomers mentioned may also comprise nonionic monomers, for example vinylpyrrolidone, (partially saponified) vinyl acetate or hydroxy(meth)acrylate, as interpolymerized comonomers.

Processes for preparing diallyldialkylammonium homo- or copolymers are described for example in U.S. Pat. No. 4,742,134, U.S. Pat. No. 5,283,306 and EP-A 0 264 710.

In a particularly preferred embodiment, inventive aqueous pretreatment liquors comprise polymers or copolymers of diallyldialkylammonium monomers, especially diallyldimethylammonium chloride homopolymer, as polycationic compounds (C), at least one melamine derivative as resin (A) and one or more associative thickeners of the formula I, II and/or III as thickeners (B).

As well as said components (A), (B) and (C), inventive aqueous pretreatment liquors may comprise additives as a component (D). Additives are for example aldehyde scavengers, defoamers, emulsifiers, solvents, biocides, deaerators and wetting agents.

Useful aldehyde scavengers include for example urea and carbamates.

Useful defoamers include for example silicone defoamers such as for example those of the formula HO—(CH₂)₃—Si(CH₃)[OSi(CH₃)₃]₂. Silicone-free defoamers are also suitable, examples being multiply alkoxylated alcohols, for example fatty alcohol alkoxylates, preferably 2- to 50-tuply ethoxylated preferably unbranched C₁₀-C₂₀-alkanols, unbranched C₁₀-C₂₀-alkanols and 2-ethylhexan-1-ol.

Useful emulsifiers include for example cationic, anionic, zwitterionic and nonionic surfactants. Nonionic surfactants are particularly useful, examples being multiply and especially 5- to 100-tuply alkoxylated fatty alcohols.

Useful biocides (also known as preservatives) include for example 1,2-benzisothiazolin-3-one (“BIT”) (commercially available as Proxel® brands from Avecia Lim.) and its alkali metal salts; useful biocides also include 2-methyl-2H-isothiazole-3 (“MIT”) and 5-chloro-2-methyl-2H-isothiazol-3-one (“CIT”).

Useful deaerators are for example those based on polyethersiloxane copolymers, for example H-(EO)ₐ—O—(CH₂)₃—Si(CH₃)[OSi(CH₃)₃]², where a for example represents an integer in the range from 1 to 10 and EO represents OCH₂CH₂.

Useful wetting agents include for example nonionic, anionic or cationic surfactants, especially ethoxylation and/or propoxylation products of fatty alcohols or propylene oxide-ethylene oxide block copolymers, ethoxylated or propoxylated fatty or oxo alcohols, also ethoxylates of oleic acid or alkylphenols, alkylphenol ether sulfates, alkylpolyglycosides, alkyl phosphonates, alkylphenyl phosphonates, alkyl phosphates or alkylphenyl phosphates.

The present invention further provides aqueous pretreatment liquors comprising
(A) at least one resin selected from melamine derivatives, dimethyloldihydroxy-ethyleneurea (DMDHEU) and derivatives of DMDHEU,
(B) at least one thickener,
(C) optionally at least one polycationic compound, and
(D) optionally at least one additive

In one embodiment of the present invention inventive aqueous pretreatment liquors comprise
(A) from 0.1% to 20%, preferably from 0.1% to 15% by weight and more preferably from 0.1% to 10% by weight of at least one resin selected from melamine derivatives, dimethyloldihydroxyethyleneurea (DMDHEU) and derivatives of DMDHEU,
(B) from 0.1% to 30% by weight of thickener,
(C) from 0.1% to 50% by weight of polycationic compound, and
(D) from 0% to 30% by weight of additives.

The solids content of inventive pretreatment liquors may be for example in the range from 10 g/l to 600 g/l and preferably in the range from 50 g/l to 500 g/l.

Inventive pretreatment liquors are particularly useful for practicing step (a) of the present invention's process for coloration of textile substrates.

The present invention further provides treatment compositions comprising said components (A), (B), if appropriate (C) and if appropriate (D), from which inventive aqueous pretreatment liquors are obtainable by dilution with water.

The present invention further provides a process for producing inventive pretreatment liquors by diluting inventive treatment compositions with water. However, inventive pretreatment liquors can be produced by stirring water with component (A) and (B), if appropriate (C) and if appropriate (D) in successive steps.

A further aspect of the present invention comprises textile substrates obtainable by the present invention's process for coloration of textile substrates. Textile substrates according to the present invention are notable not only for particular brilliance of the color and the contours and particularly good adhesion and hence fastness of the print, for example for particularly good rubfastnesses, wetrubfastnesses and washfastnesses, but also for a particularly pleasant hand.

The invention is illustrated by working examples.

### Preparation of Melamine Derivatives Used According to Invention

I.1. General Procedure Illustrated by Reference to a Melamine Derivative A1 Formed from Melamine Formaldehyde:Diethylene Glycol 1:2.2:5 (Molar Ratios)

115.5 g of a 40% by weight aqueous solution of formaldehyde (1.54 mol) were placed in a 1 l three neck flask equipped with dropping funnel and stirrer and adjusted to pH 8.5 with 25% by weight aqueous NaOH. Melamine (88.2 g, 0.7 mol) was subsequently added as a solid before heating to 80° C. for 30 min, whereafter diethylene glycol (371.3 g, 3.5 mol) was added dropwise before the pH was adjusted to 5.3 with 30% by weight of aqueous HNO₃. The resulting solution was heated to 60° C. for 1 h. The pH was subsequently adjusted to 8 with 25% by weight NaOH. About 80 ml of a mixture of water and diethylene glycol were subsequently distilled off at 100 mbar and 100° C. to leave melamine derivative A1.

Analysis: nonvolatiles: 42.5% by weight (determined by 2 h drying in a drying cabinet at 120° C.), H₂O by Karl Fischer: 3.7% by weight, dynamic viscosity η: 850 mPa·s, determined using a plate-cone viscometer.

### I.2 Preparation of Further Melamine Derivatives Used According to Invention

Prescription 1.1 was repeated except that the amounts of formaldehyde and diethylene glycol evident from table 1 were added.

TABLE 1
Preparation of melamine derivatives used according to invention

| | Molar ratio | | | | n.f.A | H₂O | η |
|---|---|---|---|---|---|---|---|
| No. | Melamine | Formaldehyde | DEG | CH₃OH | [% by weight] | [% by weight] | [mPa · s] |
| A1 | 1 | 2.2 | 5 | — | 42.5 | 3.7 | 850 |
| A2 | 1 | 2.6 | 10 | — | 23.2 | 2.6 | 145 |
| A3 | 1 | 2.6 | 7 | — | 34.6 | 2.3 | 310 |
| A4 | 1 | 2.6 | 5 | — | 50.5 | 3.5 | 1040 |
| A5 | 1 | 2.4 | 5 | — | 45.5 | 4.1 | 820 |
| A6 | 1 | 2.0 | 5 | — | 44.2 | 4.0 | 710 |
| A7 | 1 | 1.8 | 5 | — | 43.0 | 3.1 | 580 |
| A8 | 1 | 1.6 | 5 | — | 40.7 | 3.5 | 560 |
| A9 | 1 | 1.4 | 7.5 | — | 22.1 | 4.6 | 160 |
| A10 | 1 | 3 | — | 3 | 90 | n.d. | n.d. |
| A11 | 1 | 2 | — | 3 | 70 | n.d. | n.d. |

n.d.: not determined
Abbreviations: n.f.A.: nonvolatiles (determined by 2 h drying in a drying cabinet at 120° C.), DEG: diethylene glycol.

### II. Production of Inventive Pretreatment Liquors

Component (A): melamine derivative as per table 1 or 2
Component (B): B1, see hereinbelow
Component (C): C1 or C2, see hereinbelow.

To produce 1 kg of inventive pretreatment liquor, completely ion-free water was stirred with component (C) until everything had gone into solution. This was followed by addition of components (B) and (D), and homogenization, with stirring. Then resin (A) according to table 1 was added.

Inventive liquors as per table 2 were produced.

### Key to Abbreviations:

B1: associative thickener, reaction product of hexamethylene diisocyanate (HDI) with ethoxylated n-C₁₈H₃₇OH of M_{w} 10 000 g/mol, the ethoxylated fatty alcohol being used in an excess of 50 mol %, based on isocyanate groups;
C1: polyethyleneimine, M_{w} 25 000 g/mol
C2: diallyldimethylammonium chloride homopolymer; M_{w} 10 000 g/mol
D1: tri-n-butyl phosphate defoamer
D2: 20% by weight of solution of 1,2-benzisothiazolin-3-one in propylene glycol
D3: dispersing binder according to Example IV.

TABLE 2
Inventive pretreatment liquors

| Pretreatment liquor No. | (A) [g/l] | (B) [g/l] | (C) [g/l] | (D) [g/l] |
|---|---|---|---|---|
| F1 | A10: 10 | 15 | C1: 200 | D1: 2, D2: 2 |
| F2 | A11: 5 | 25 | C2: 220 | D2: 2, D3: 3 |
| F3 | A2: 5 | 25 | C2: 220 | D2: 2, D3: 3 |

### III. Inventive Coloration of Woven Textile Fabric

Wovens G3.1 to G3.3 were used
G3.1 Cotton 283, bleached, basis weight 119.7 g/m²
G3.2 cotton-polyester blend 50/50, basis weight 114.7 g/m²
G3.3 polyester microfiber, basis weight 104.23 g/m²

### III.1. General Prescription for Step (a)

Fabrics G3.1. G3.2 and G3.3 were each treated with a pretreatment liquor as per table 2 on a pad-mangle from Mathis (model No. HVF63003). The nip pressure of the rolls was 2.2 bar, resulting in a wet pickup of 60%. The application speed was 1 m/min. The pretreated fabric was subsequently tenter dried at 80° C.

Woven fabrics pretreated according to the present invention were obtained

### III.2 Printing by Ink Jet Process

### III.2.1. Production of Inks for Ink Jet Process

The hereinbelow recited inks for the ink jet process were produced by mixing the constituents identified in table 4. Initially, mix components M1 to M3 were produced by introducing each of the constituents recited in table 3 into a ball mill, making up to 100 ml with distilled water in each case and dispersing. A glass beaker was then used as a location to formulate ink T1 from mix component M1 and the ingredients of table 5, ink T2 from mix component M2 and the ingredients of table 4 and ink T3 from mix component M3 and the ingredients of table 5, making up to 100 ml with distilled water each time.

Wetting agent 1: [(CH₃)₃Si]₂Si(CH₃)[CH₂]₃—O—(CH₂CH₂O)₃H
Biocide 1; 20% by weight of solution of 1,2-benzisothiazolin-3-one in dipropylene glycol

TABLE 3
Composition of mix components M1 to M3

| | M1 | M2 | M3 |
|---|---|---|---|
| C.I. Pigment Red 122 | 10 | | |
| C.I. Pigment Blue 15:3 | | 8 | |
| C.I. Pigment Black 7 | | | 9 |
| Dispersing binder D3 | 30 | 24.36 | 27.2 |
| Melamine derivative A10 | 4.44 | 3.55 | 4 |
| 1,2-Propylene glycol | 5 | 4 | 4.5 |
| Biocide 1 | 2.6 | 2.0 | 2.3 |
| Tri-n-butyl phosphate | 0.04 | 0.04 | 0.02 |

All use levels reported in g/100 ml. 100 ml of mix component M1, M2 and M3 were produced in each case.

TABLE 4
Composition of inks T1 to T3

| | T1 | T2 | T3 |
|---|---|---|---|
| Wetting agent 1 | 0.5 | 0.5 | 1.2 |
| Urea | 1.0 | 1.0 | 1.0 |
| Biocide 1 | 2.5 | 2.5 | 2.5 |
| Glycerol | 16.0 | 13.0 | 9.0 |
| Polyethylene glycol, | 4 | 3.25 | 1.75 |
| Mₙ 250 g/mol | | | |
| 1,2-Pentanediol | 4.5 | 4.5 | 4.5 |
| Mix component M1 | 20 | | |
| Mix component M2 | | 20 | |
| Mix component M3 | | | 30 |

All use levels reported in g/100 ml. 100 ml of ink T1, T2 and T3 were produced in each case.

III.2 Printing with Inks

Cotton fabric, polyester microfiber fabric and cotton-polyester blend fabric were each printed with an ink on a Mimaki TX 1600 S printer.

Quantitative examinations were carried out to determine the colorimetric properties. The measurements were carried out using an X-Rite CA22 spectrophotometer and analyzed using X-Rite Color Master software. A sample of the respective unpretreated fabric was used as a standard for the colorimetric measurements. A higher value for color strength and for chroma (as per M. Richter, Einführung in die Farbmetrik, DeGruyter, Berlin 1981) for fabric pretreated according to the present invention thus is evidence of an improved printing outcome.

The present invention's pretreatment of the respective fabric has led to improved ink holdout and hence to better resolution.

### Rubfastness:

| | | Unpretreated | | Pretreatment with F1 | | Pretreatment with F2 | |
|---|---|---|---|---|---|---|---|
| | Ink | dry | wet | dry | wet | dry | wet |
| G3.1 | T1 | 4 | 3 | 4 | 3 | 4 | 4 |
| G3.1 | T2 | 3 | 3 | 3 | 3 | 4 | 4 |
| G3.1 | T3 | 3 | 3 | 3 | 4 | 4 | 4 |
| G3.2 | T1 | 4 | 3 | 4 | 3 | 4 | 4 |
| G3.2 | T2 | 3 | 3 | 3 | 3 | 4 | 3 |
| G3.2 | T3 | 3 | 3 | 3 | 4 | 4 | 4 |
| G3.3 | T1 | 4 | 3 | 4 | 3 | 4 | 4 |
| G3.3 | T2 | 3 | 3 | 3 | 3 | 4 | 4 |
| G3.3 | T3 | 3 | 3 | 3 | 4 | 4 | 4 |

### Color Strength:

| | | Color | Pretreatment with F1 | | Pretreatment with F2 | |
|---|---|---|---|---|---|---|
| | | strength | color | Δ | color | Δ |
| | Ink | unpretreated | strength | chroma | strength | chroma |
| G3.1 | T1 | 100 | 150.35 | 6.29 | 148.92 | 5.46 |
| G3.1 | T2 | 100 | 125.17 | 0.52 | 132.51 | 1.02 |
| G3.1 | T3 | 100 | 156.13 | 4.71 | 136.13 | 3.71 |
| G3.2 | T1 | 100 | 180.85 | 8.43 | 182.65 | 6.54 |
| G3.2 | T2 | 100 | 210.91 | 0.61 | 201.12 | 0.84 |
| G3.2 | T3 | 100 | 198.15 | 6.75 | 188.98 | 6.01 |
| G3.3 | T1 | 100 | 230.5 | 10.97 | 224.03 | 13.98 |
| G3.3 | T2 | 100 | 247.39 | 0.62 | 220.12 | 0.54 |
| G3.3 | T3 | 100 | 217.17 | 6.39 | 225.62 | 8.56 |

Pretreated and printed fabrics according to the present invention possessed excellent hand.

### IV. Preparation of a Dispersing Binder D3 in Aqueous Solution

8.85 g of neopentylglycol, 7.03 g of dimethylpropionic acid, 51.95 g of polyesterdiol and 53.01 g of 4,4′-diphenyl diisocyanate were dissolved in 118.74 g of tetrahydrofuran previously distilled over sodium/benzophenone by a standard laboratory method. A drop of di-n-butyltin dilaurate was added and the reaction solution was brought to the boil. It was heated under reflux until free isocyanate was no longer detectable (titrimetrically in accordance with German standard specification DIN 53 185). The reaction solution was then cooled down by means of an ice bath and admixed with a solution of 6.25 g of diethanolamine in 6.25 g of distilled tetrahydrofuran and thereafter with 5.4 g of triethylamine. 315 g of water were added and the tetrahydrofuran was distilled off to leave dispersing binder D3 in aqueous solution, solids content 33% by weight.

The polyesterdiol used was a polyesterdiol having a hydroxyl number of 140 mg of KOH/g of polyesterdiol, determined according to German standard specification DIN 53240, obtained from isophthalic acid, adipic acid and 1,4-cyclohexanedimethanol in a molar ratio of 1:1:2.2.

1-14. (canceled)

15. A process for coloring a textile substrate, which comprises pre-treating a textile substrate
(a) with an aqueous pretreatment liquor comprising
(A) at least one resin selected from melamine derivatives, dimethylol-dihydroxyethyleneurea (DMDHEU) and derivatives of DMDHEU, and
(B) at least one thickener,
(C) at least one polycationic compound, and
(D) optionally at least one additive, and thereafter
(b) printing by an ink jet process.

16. The process according to claim 15, wherein textile substrate pretreated according to (a) is dried before being printed according to step (b).

17. The process according to claim 15, wherein at least one melamine derivative in step (a) is a condensation product of melamine with at least one aldehyde selected from C₆-C₁₄-arylaldehyde and aliphatic aldehydes, said condensation product having been etherified with at least one aliphatic alcohol if appropriate.

18. The process according to claim 15, wherein aliphatic aldehydes are selected from formaldehyde and C₁-C₁₀-alkylaldehyde.

19. The process according to claim 15, wherein at least one melamine derivative in step (a) is a melamine derivative obtainable by reaction of melamine with 1 to less than 3 equivalents of at least one aldehyde and subsequent etherification with 4.5 to 10 equivalents of at least one polyhydric aliphatic alcohol.

20. The process according to claim 15 wherein at least one polyhydric aliphatic alcohol is ethylene glycol, diethylene glycol or triethylene glycol.

21. The process according to claim 15 wherein at least one thickener (B) is an associative thickener of the general formula I to III
U[-T-(E)_{y}-]ₓ—U I
U-(E)_{y}-U II
U-T-U III
where
E is in each occurrence the same or different and selected from —CH₂—CH₂, —CH₂—CH(CH₃)—, —CH₂—CH(C₂H₅)—,
y is an integer from 1 to 100 000,
T is in each occurrence the same or different and a diisocyanate-derived unit,
x is an integer from 1 to 500,
U is in each occurrence the same or different and selected from units derived from aliphatic alcohols, thiols, amines or carboxylic acids each having 4 or more carbon atoms or aromatic alcohols, thiols, amines or carboxylic acids each having 6 or more carbon atoms, alcohols, thiols, amines or carboxylic acids having C₇-C₁₃-aralkyl moieties or heteroaromatic alcohols, thiols, amines or carboxylic acids.

22. The process according to claim 15, wherein at least one polycationic compound (C) is a polymer or copolymer of a diallyldialkylammonium monomer.

23. An aqueous pretreatment liquor comprising
(A) at least one resin selected from melamine derivatives, dimethylol-dihydroxyethyleneurea (DMDHEU) and derivatives of DMDHEU,
(B) at least one thickener,
(C) at least one polycationic compound, and
(D) optionally at least one additive.

24. The aqueous pretreatment liquor according to claim 23 that comprises
(A) from 0.1% to 50% by weight of at least one resin selected from melamine derivatives, dimethyloldihydroxyethyleneurea (DMDHEU) and derivatives of DMDHEU,
(B) from 0.1% to 50% by weight of thickener.
(C) from 0.1% to 50% by weight of polycationic compound, and
(D) from 0% to 30% by weight of additives.

25. A pretreatment composition comprising
(A) at least one resin selected from melamine derivatives, dimethylol-dihydroxyethyleneurea (DMDHEU) and derivatives of DMDHEU,
(B) at least one thickener,
(C) at least polycationic compound, and
(D) optionally at least one additive.

26. A process for producing an aqueous pretreatment liquor by mixing at least one pretreatment composition according to claim 25 with water.

27. A textile substrate prepared by a process of claim 15.
